(19) United States
(12) Patent Application Publication
(10) Pub. No.: US 2024/0339859 A1
(43) Pub. Date: Oct. 10, 2024

(54) System, Method, and Computer-Implemented Application for Sharing Battery Power Between Portable Electronic Devices

(71) Applicant: Adrian Johnson, Cedar Bluff, VA (US)

(72) Inventor: Adrian Johnson, Cedar Bluff, VA (US)

(21) Appl. No.: 18/584,530

(22) Filed: Feb. 22, 2024

Related U.S. Application Data
(60) Provisional application No. 63/494,554, filed on Apr. 6, 2023.

(51) Int. Cl. H02J 7/34; G06F 3/04855; H02J 7/00; H02J 50/80

(52) U.S. Cl. CPC H02J 7/342; G06F 3/04855; H02J 7/00034; H02J 50/80; H02J 2207/30

(57) ABSTRACT

A method and system for sharing battery power between two smart devices is disclosed. A mobile application is installed on both devices and facilitates the transfer of battery power either through a wired (charging cable) or wireless medium. The process including the selection of a recipient device and the specific percentage of battery power to be transferred, all managed through an interface provided by the application on the sender device. The memory of the devices stores device identifiers and the processor of the sender device controls the power charging port to function effectively in the battery power transfer process. The application provides a better way of managing battery power between portable electronic devices, offering a practical solution in various scenarios where power sharing is essential.

### CROSS-REFERENCE TO RELATED APPLICATION

The present application claims priority to, and the benefit of, U.S. Provisional Application No. 63/494,554, which was filed on Apr. 6, 2023, and is incorporated herein by reference in its entirety.

### FIELD OF THE INVENTION

The present invention generally relates to the field of charging batteries of smartphones and similar devices. More specifically, the present invention relates to a novel method and system for sharing battery power between two smart devices. The method is performed by a mobile software application that enables to transfer power from one first smart device to a second smart device using a wired or a wireless connection. The application can be configured to set a power limit for transfer and the mobile application is required to be active on both the sender device and the recipient device. Accordingly, the present disclosure makes specific reference thereto. Nonetheless, it is to be appreciated that aspects of the present invention are also equally applicable to other like applications, devices, and methods of manufacture.

### BACKGROUND

By way of background, in today's fast-paced world, portable electronic devices such as smartphones have become indispensable. Smartphones and other similar electronic devices serve a plurality of functions, such as basic communication through calls and texts, browsing the internet, managing work-related activities, and accessing different applications for entertainment and utility. The continuous usage of the devices leads to a significant drain of the batteries of such devices. Often, batteries are completely drained and users find themselves with low or zero battery power, especially when they are away from home or other familiar environments.

Individuals often carry portable chargers or power banks to charge batteries of their smartphones. However, such portable chargers are often bulky and require additional space, making them cumbersome to carry around, especially during commuting. Additionally, the cost of purchasing a high-quality portable charger cannot be afforded by some users. Also, individuals may not always find a power outlet, especially in public spaces or in outdoor settings to recharge their smartphones. Further, individuals may forget to carry their phone chargers or may not have them readily accessible when needed.

As a result, complete draining of the batteries of smartphones and other similar devices is common preventing individuals from using their smartphones. The inability to use their phone for individuals can be more than just an inconvenience and can also pose safety concerns, particularly in emergency situations where immediate communication is crucial. The current market does not offer a solution that overcomes the problems mentioned above and individuals desire a novel approach for recharging batteries of their mobile device such as by directly transferring power between smartphones or similar electronic devices.

Therefore, there exists a long-felt need in the art for a method for directly transferring battery power between smartphones or similar electronic devices. There is also a long-felt need in the art for a method that enables users to share battery power between two portable electronic devices conveniently. Additionally, there is a long-felt need in the art for a novel charging solution for mobile devices that reduces use of the portable charging devices for mobile devices. Moreover, there is a long-felt need in the art for a novel application that enables the transfer of battery power from one portable electronic device to another. Furthermore, there is a long-felt need in the art for a mobile application that is installed in two portable electronic devices for transferring battery power between the two devices. Also, there is a long-felt need in the art for a software application that reduces dependency upon power outlets and portable chargers for recharging battery power of a mobile device. Finally, there is a long-felt need in the art for a convenient, cost-effective, and user-friendly solution to recharge battery power of portable electronic devices by transferring power from another portable electronic device.

The subject matter disclosed and claimed herein, in one embodiment thereof, comprises a method for sharing battery power between two smart devices such as smartphones. The method comprises the steps of storing, in the memory of each smart device, computer-implemented instructions for sending and receiving battery power. The smart devices include a first smart device and a second smart device wherein the method also includes receiving, a selection of the second smart device, on an interface provided by the computer-implemented instructions of the first smart device. Receiving, a selection of battery power percentage to be transferred from the first smart device to the second smart device. Transferring the battery power from the first smart device to the second smart device through a charging cable or wireless medium and according to the selected battery power percentage, wherein an authorization is received from the application on the second device for initiating the battery power transfer from the first device to the second device.

In this manner, the computer-implemented battery power sharing method and associated system of the present invention accomplish all of the foregoing objectives and provide users a software application capable of transferring battery power from one electronic device to another electronic device. The application when installed on both the devices enables users to select the level of battery power that can be transferred between the devices. Battery power can be transferred using both wired and wireless mechanisms and prevents individuals from running out of battery when traveling or away from a nonportable power source.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for sharing battery power between two smart devices. The method comprises the steps of storing, in the memory of each smart device, computer-implemented instructions for sending and receiving battery power. The smart devices include a first smart device and a second smart device wherein the method also includes receiving, a selection of the second smart device, on an interface provided by the computer-implemented instructions of the first smart device. Receiving, a selection of battery power percentage to be transferred from the first smart device to the second smart device. Transferring the battery power from the first smart device to the second smart device through a charging cable or wireless medium and according to the selected battery power percentage.

In another aspect, a battery power sharing system for transferring battery power from one portable electronic device to another portable electronic device is disclosed. The system includes a first smart device and a second smart device, a mobile application installed on both the first and second smart devices, the mobile application is configured to enable transfer of battery power from the first smart device to the second smart device, and a charging cable and a wireless charging protocol for transferring battery power between the first and second smart devices via a wired and a wireless medium. The mobile application is adaptable based on the operating system requirements of the first and second smart devices.

In yet another embodiment, a method for sharing battery power between two smart devices including a first smart device and a second smart device is described. The method includes the steps of installing a mobile application on a first smart device and a second smart device, configuring the mobile applications to enable battery power transfer from the first smart device to the second smart device, selecting a battery power percentage to be transferred from the first smart device to the second smart device, wherein the power transfer between the first and second smart devices is performed using a wired or wireless medium.

In yet another embodiment, the mobile application is configured to display a user interface for selecting a compatible smart device for battery power transfer and a scroll bar for selecting a percentage of battery power to transfer.

In a further embodiment, the mobile application includes a feature for blacklisting certain smart devices to prevent battery power sharing.

In yet another aspect of the present invention, the mobile application displays an authorization notification for approval before receiving the battery power from a smart device.

In yet another embodiment, a system for sharing battery power between two electronic computing devices is disclosed. The system comprising a first computing device and a second computing device, the first computing device includes a battery, a memory storing the device identifier, instructions specifying battery power transfer from the first computing device to the second computing device, a processor configured to control the power charging port to function as a sender when the charging cable is plugged into the power charging port, transfer battery power according to a selected power level to the second computing device.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of an example environment of a cell phone battery power sharing system of the present invention in accordance with the disclosed architecture;

FIG. 2 illustrates an exemplary interface displayed by the smartphone application installed in the first smart device for enabling battery power transfer to the second smart device in accordance with one embodiment of the present invention;

FIG. 3 illustrates another exemplary user interface displayed by the cell phone battery power transfer mobile application of the present invention for transferring battery power in accordance with the disclosed architecture;

FIG. 4 illustrates an exemplary notification displayed by the cell phone battery power transfer application in a battery power receiving smart device in accordance with one embodiment of the present invention;

FIGS. 5A and 5B illustrate perspective views showing battery power transfer through wired medium and wireless medium respectively in accordance with embodiments of the present invention; and

FIG. 6 displays a block diagram of an exemplary smart device used for sharing battery power using the cell phone battery power sharing application and system of the present invention in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a method for directly transferring battery power between smartphones or similar electronic devices. There is also a long-felt need in the art for a method that enables users to share battery power between two portable electronic devices conveniently. Additionally, there is a long-felt need in the art for a novel charging solution for mobile devices that reduces use of the portable charging devices for mobile devices. Moreover, there is a long-felt need in the art for a novel application that enables the transfer of battery power from one portable electronic device to another. Furthermore, there is a long-felt need in the art for a mobile application that is installed in two portable electronic devices for transferring battery power between the two devices. Also, there is a long-felt need in the art for a software application that reduces dependency on power outlets and portable chargers for recharging battery power of a mobile device. Finally, there is a long-felt need in the art for a convenient, cost-effective, and user-friendly solution to recharge battery power of portable electronic devices by transferring power from another portable electronic device.

The present invention, in one exemplary embodiment, is a method for sharing battery power between two smart devices including a first smart device and a second smart device. The method includes the steps of installing a mobile application on a first smart device and a second smart device, configuring the mobile applications to enable battery power transfer from the first smart device to the second smart device, selecting a battery power percentage to be transferred from the first smart device to the second smart device, wherein the power transfer between the first and second smart devices is performed using a wired or wireless medium.

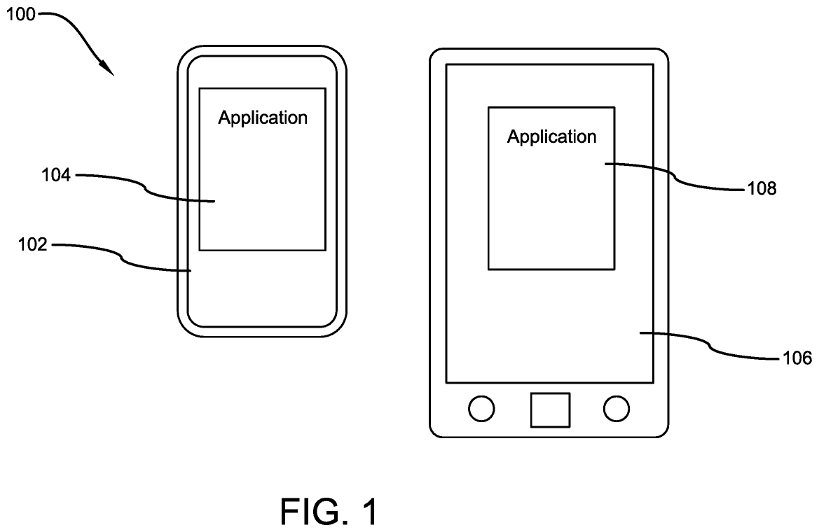

Referring initially to the drawings, FIG. 1 illustrates a schematic diagram of an example environment of a cell phone battery power sharing system of the present invention in accordance with the disclosed architecture. The cell phone battery power sharing system 100 of the present invention is designed to transfer battery power from a first smart device to a second smart device through either a wired or wireless transfer medium. The battery power sharing system 100 includes a first smart device 102 having an installed cell phone battery sharing mobile application 104 and a second smart device 106 having an installed corresponding cell phone battery sharing mobile application 108. It will be noted that software applications 104, 108 are the same mobile applications which can be customized based on the type and requirements (such as operating system requirements) of the smart devices 102, 106.

The smart devices 102, 106 included in the system 100 can be the same or different smart devices and can be one or more of a smartphone, a mobile phone, a cellular phone, a personal digital assistant (PDA), a GPS device, a smartbook, a netbook, an ultra-mobile personal computer, a wearable computing device, a head-mounted display, any AR/VR device, or any other personal computing device. Depending on the design and configuration of the smart devices 102, 106, the software applications 104, 108 can enable any of the wired or wireless power transfer between the smart devices 102, 106.

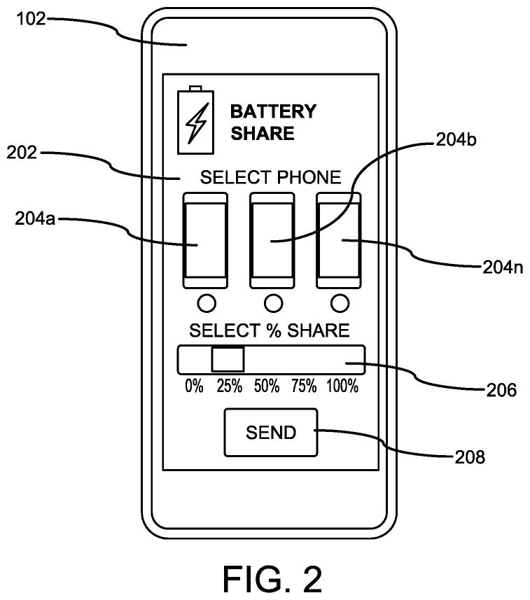

FIG. 2 illustrates an exemplary interface displayed by the smartphone application 104 installed in the first smart device for enabling battery power transfer to the second smart device in accordance with one embodiment of the present invention. The mobile application 104 is configured to display the user interface 202 for enabling a user to configure parameters to enable transfer of battery power of the device 102 to another smart device. As illustrated, the interface 202 displays a plurality of smart devices 204a-n compatible with the first smart device 102 for transferring battery power. The application 104 tracks the battery power, operating system, and battery transfer protocol requirements of the smart device 102 in which the application 104 is installed for displaying the list of compatible smart devices 204a-n. In some embodiments, the list of the compatible smart devices 204a-n can include the smart devices to which the smart device 102 has historically transferred battery power. One smart device can be selected from the list of the smart devices 204a-n for transferring battery power from the first smart device 102.

A battery transfer percentage scroll bar 206 is offered by the interface 202 which enables a user to select a predetermined percentage of the total battery power of the first device 102 for transfer to another device. The application 104 enables users to transfer up to 100% of the battery power to another device, thereby eliminating use of portable charging devices and reducing use of power outlets.

It should be noted that depending on the selected smart device and the battery percentage, the application 104 can suggest one of the wired or wireless power transfer medium for transferring battery power from the first device 102 to the selected smart device. After selection of the receiving smart device and the battery percentage, the “Send” icon 208 can be activated to start battery power transfer from the first smart device 102.

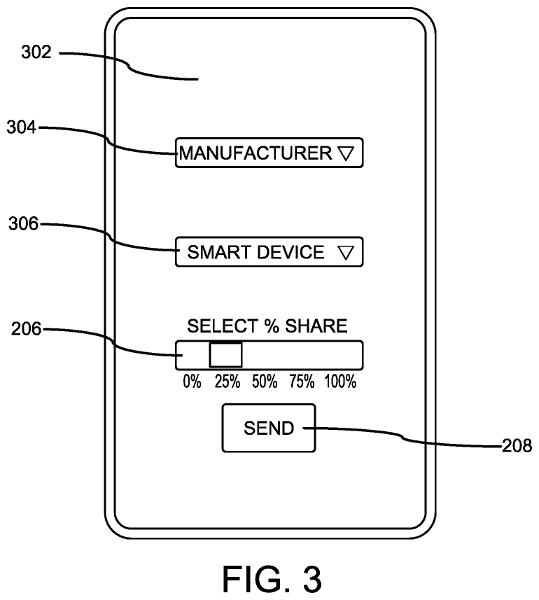

FIG. 3 illustrates another exemplary user interface displayed by the cell phone battery power transfer mobile application of the present invention for transferring battery power in accordance with the disclosed architecture. In the present embodiment, the interface 302 displays a manufacturer's drop down menu 304 including a plurality of smart device manufacturers whose smart devices are compatible with the smart device 102. A smart device drop down menu 306 displays a list of the smart devices compatible with the smart device 102 wherein the list displays smart devices of the selected manufacturer from the menu 304. A battery transfer percentage scroll bar 206 enables users to select a specific battery percentage to be transferred to the selected smart device.

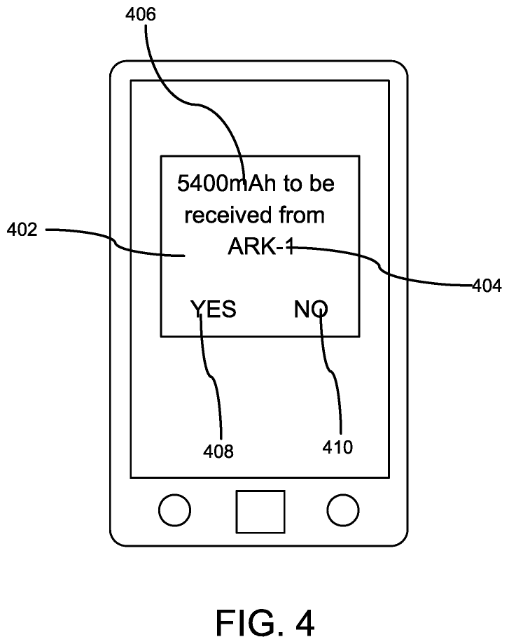

FIG. 4 illustrates an exemplary notification displayed by the cell phone battery power transfer application in a battery power receiving smart device in accordance with one embodiment of the present invention. It should be noted that both the battery power sender device (102 in FIG. 1) and the battery power receiver device (106 in FIG. 1) must include the cell phone battery power transfer application for the battery power to be transferred between the devices. The application 108 in the receiver device 106 displays a notification 402 for approval of receiving battery power when the “Send” button (as illustrated in FIGS. 2 and 3) is activated on the sender device. The notification 402 is configurable and can be deactivated by the receiving user based on the preferences and choices.

The battery power notification 402 displays a unique identifier 404 of the sender device 102 and the information 406 of the battery power to be received from the sender device. An authorization using the ‘YES’ button 408 enables a successful initiation of the battery power transmission between the devices. If the ‘NO’ button 410 is selected by the user, then the battery power is not transferred and an alert can be displayed on the application installed in the sender smart device.

In some embodiments, the mobile application enables users to blacklist one or more smart devices, thereby preventing sharing of battery power with the blacklisted smart devices. The blacklisted devices can also be removed from the blacklist depending on the preferences of the user.

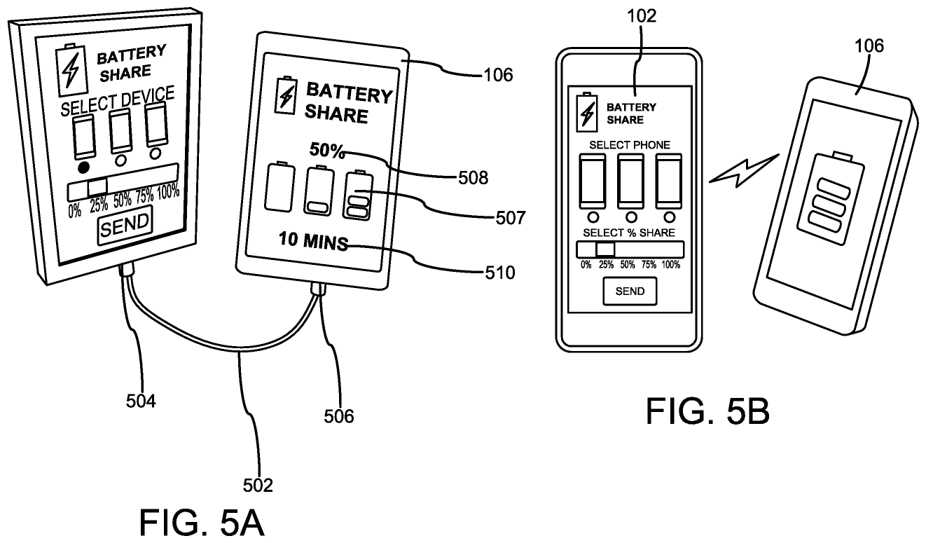

FIGS. 5A and 5B illustrate perspective views showing battery power transfer through wired medium and wireless medium respectively in accordance with embodiments of the present invention. As illustrated in FIG. 5A, a conventional charging cable 502 compatible with the charging ports 504, 506 of the smart devices 102, 106 can be used for sharing battery power between the smart devices. During transfer of battery power, the application 108 in the receiving smart device 106 displays a real-time charging status 507 along with charged battery percentage 508 and estimated time 510 left for preconfigured battery power sharing. As illustrated in FIG. 5B, the two devices 102, 106, when are compatible with wireless charging, can share battery power using the wireless charging protocol.

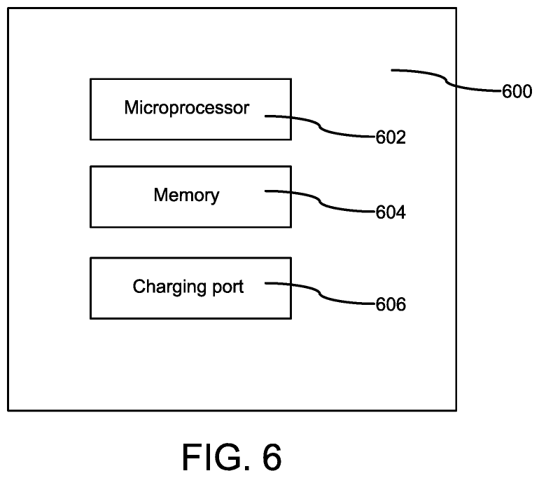

FIG. 6 displays a block diagram of an exemplary smart device used for sharing battery power using the cell phone battery power sharing application and system of the present invention in accordance with one embodiment of the present invention. The smart device 600 can be used in different embodiments of the present invention both as a sender device and a receiver device. The smart device 600 includes a microprocessor 602 which can be any suitable processor for executing computer-implemented instructions of the cell phone battery power sharing application. A memory 604 stores the smart device identifier and the computer-implemented instructions of the application. The memory 604 further stores the blacklisted smart devices. The memory 604 can be any suitable memory for storing instructions executed by the microprocessor 602. Examples of such computer-readable storage mediums or memory 604 include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory.

The power charging port 606 is adapted to both send and receive battery power using a charging cable. The microprocessor 602 configures the port 606 to function as a receiver or sender when the charging cable is plugged into the charging port 606.

The term “coupled” as used herein is defined as connected, although not necessarily directly and not necessarily mechanically. A device or structure that is “configured” in a certain way is configured in at least that way, but may also be configured in ways that are not listed.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

The present invention can be used in connection with any phone, gaming console or smart device such as, but not limited to, smart watches, iPads, computers, and anything ese that the mobile application can be downloaded onto.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cell phone battery power sharing system”, “battery power sharing system”, and “system” are interchangeable and refer to the portable electronic device battery power sharing system 100 of the present invention. Similarly, as used herein “cell phone battery sharing mobile application”, “software application”, and “application” are interchangeable and refer to the cell phone battery sharing mobile application 104, 108 of the present invention.

Notwithstanding the foregoing, the portable electronic device battery power sharing system 100 and the cell phone battery sharing mobile application 104, 108 of the present invention can be of any suitable configuration as is known in the art without affecting the overall concept of the invention, provided that it accomplishes the above-stated objectives. One of ordinary skill in the art will appreciate that the configuration and specification of the components of the portable electronic device battery power sharing system 100 and the cell phone battery sharing mobile application 104, 108 as shown in FIGS. is for illustrative purposes only, and that many other configurations of the portable electronic device battery power sharing system 100 and the cell phone battery sharing mobile application 104, 108 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A battery power sharing system comprising:
a transfer battery power system having a battery sharing mobile application, a user interface, and a microprocessor for sharing battery power from a first smart device to a second smart device;
wherein said first smart device having an installed said battery sharing mobile application and said second smart device having said battery sharing mobile application;
wherein said first smart device and said second smart device connected by said user interface;
wherein said microprocessor having a processor for executing computer-implemented instructions of said battery sharing mobile application;
wherein said battery sharing mobile application displays said user interface; and
further wherein said battery sharing mobile application having a user configured parameter for transferring battery power of said first smart device to said second smart device.

2. The battery power sharing system of claim 1, wherein said user configured parameter including a percentage of battery power of said first smart device.

3. The battery power sharing system of claim 2, wherein said user interface displays a plurality of smart devices compatible with said first smart device.

4. The battery power sharing system of claim 3, wherein said first smart device and said second smart device selected from the group consisting of one or more of a smartphone, a mobile phone, a cellular phone, a personal digital assistant (PDA), a GPS device, a smartbook, a netbook, an ultra-mobile personal computer, a wearable computing device, a head-mounted display, and an AR/VR device.

5. The battery power sharing system of claim 4, wherein said first smart device is different than said second smart device.

6. The battery power sharing system of claim 5, wherein said transferring battery power of said first smart device to said second smart device is wireless.

7. The battery power sharing system of claim 5, wherein said transferring battery power of said first smart device to said second smart device including a cable connecting said first smart device with said second smart device.

8. A method of transferring battery power from one device to another device, the method comprising the following steps:
providing a transfer battery power system having a battery sharing mobile application, a user interface, and a microprocessor for sharing battery power from a first smart device to a second smart device; wherein said first smart device having an installed said battery sharing mobile application and said second smart device having said battery sharing mobile application;
connecting said first smart device to said second smart device with said user interface;
displaying said user interface with said battery sharing mobile application; and
transferring battery power of said first smart device to said second smart device with said battery sharing mobile application.

9. The method of transferring battery power from one device to another device of claim 8, wherein said transferring battery power having a user configured parameter for selectively determining a percentage of said battery power of said first smart device.

10. The method of transferring battery power from one device to another device of claim 9, wherein said user interface displays a plurality of smart devices compatible with said first smart device.

11. The method of transferring battery power from one device to another device of claim 10, wherein said first smart device and said second smart device selected from the group consisting of one or more of a smartphone, a mobile phone, a cellular phone, a personal digital assistant (PDA), a GPS device, a smartbook, a netbook, an ultra-mobile personal computer, a wearable computing device, a head-mounted display, and an AR/VR device.

12. The method of transferring battery power from one device to another device of claim 11, wherein said first smart device is different than said second smart device.

13. The method of transferring battery power from one device to another device of claim 12, wherein said transferring battery power of said first smart device to said second smart device is wireless.

14. The method of transferring battery power from one device to another device of claim 12, wherein said transferring battery power of said first smart device to said second smart device including a cable connecting said first smart device with said second smart device.

15. A method of transferring battery power from one device to another device, the method comprising the following steps:
providing a transfer battery power system having a battery sharing mobile application, a user interface, and a microprocessor for sharing battery power from a first smart device to a second smart device; wherein said first smart device having an installed said battery sharing mobile application and said second smart device having said battery sharing mobile application;
connecting said first smart device to said second smart device with said user interface;
displaying said user interface with said battery sharing mobile application;
selectively determining a percentage of battery power of said first smart device to transfer to said second smart device;
transferring said battery power of said first smart device to said second smart device with said battery sharing mobile application; and
tracking battery power of said smart device and said second smart device.

16. The method of transferring battery power from one device to another device of claim 15 further comprising the step of scrolling a bar on said battery sharing mobile application for said selectively determining the percentage of said battery power of said first smart device to transfer to said second smart device.

17. The method of transferring battery power from one device to another device of claim 16, wherein said user interface displays a plurality of smart devices compatible with said first smart device.

18. The method of transferring battery power from one device to another device of claim 17, wherein said first smart device and said second smart device selected from the group consisting of one or more of a smartphone, a mobile phone, a cellular phone, a personal digital assistant (PDA), a GPS device, a smartbook, a netbook, an ultra-mobile personal computer, a wearable computing device, a head-mounted display, and an AR/VR device.

19. The method of transferring battery power from one device to another device of claim 18, wherein said first smart device is different than said second smart device.

20. The method of transferring battery power from one device to another device of claim 19, wherein said transferring battery power of said first smart device to said second smart device is wireless.
